(19) United States
(12) Patent Application Publication
(10) Pub. No.: US 2003/0052460 A1
(43) Pub. Date: Mar. 20, 2003

(54) Connectors

(76) Inventor: Yau King Choy, Kornhill Garden (HK)

Correspondence Address: JACKSON WALKER L.L.P., Suite 2100, 112 E. Pecan Street, San Antonio, TX, 78205, US

(21) Appl. No.: 09/952,442

(22) Filed: Sep. 14, 2001

(51) Int. Cl. F16L 5/02

(52) U.S. Cl. 277/607

(57) ABSTRACT

A connector for fixing a hollow tube 16 to a plate 102 comprises a split cylindrical sleeve 104 that fits inside the tube. Threaded opposing cones 103 and 104 are drawn together by rotating a screw 101 to urge the sleeve parts radially outwards to fix the connector firmly inside the tube. The screw 101 at the same time holds the plate 101 firmly against the end of the tube. A resilient peripheral strap 107 holds the sleeve parts together before the connector is inserted in the end of the tube.

### BACKGROUND OF THE INVENTION

1. Field of the Invention

The invention relates to connectors

2. Description of Prior Art

The invention relates more particularly to ‘structural’ connectors for fixing pipes and the like together end-to-end in-line or angled with respect to one another, and for fixing pipes to a wall or other planar surface. At present, connectors that are available do not usually provide much resistance to bending moments at the end of the pipe, for different applications the connectors necessarily require different basic components, and are not simple in operation or assembly.

### SUMMARY OF THE INVENTION

It is an object of the invention to overcome or at least reduces these problems.

According to the invention there is provided a releasable connector for connecting to one end of a tube comprising a split elongate sleeve that fits snugly inside the pipe, a pair of opposing cones that are mounted at opposite ends of the sleeve, and an operating rod extending centrally through the sleeve arranged to move the cones towards each other in use to urge the sleeve radially outwards to bear against the inside of the pipe and fix the connector to the pipe in an operative configuration.

Preferably, the connector has an arm formed with a conical end to provide one of the cones.

The connector may have two arms each with a conical end to form a respective one cone, and in which the connector is arranged to join three pipe together.

The connector may have two or more arms and is arranged to connect two or more pipes together with longitudinal axes of the pipes angled to one another.

The arm may have an anchor arranged to be mounted and restrained by a cavity of a planar surface for mounting the arm to the planar surface, in which the operating arm comprises a threaded bolt partially exposed extending out of one end of the connector into the cavity, when the connector is in its operative configuration.

A centrally mounted threaded nut may be entrapped within the connector and accessible from exterior of the connector when the connector is in its operative configuraiton.

An anchor may be included for securely supporting the connector to a cavity in a planar surface in which the anchor is entrapped in the cavity and inside the sleeve when the connector is in its operative configuration

The elongate sleeve is preferably split into two equal parts.

The sleeve parts are preferably resiliently held together radially by a strap that surrounds a periphery of the sleeve.

The elongate sleeve is normally cylindrical and fits into cylindrical cavities at the ends of respective pipes. The elongate sleeve may be rectangular in cross-section to more efficiently connect to pipes having rectangular cross-section cavities at least in their ends.

The operating rod may be anchored in an opened sided body that provides one of the cones at one end and allows the operating rod to be inserted side ways into the body.

The body may have a cone at each end, respectively forming part of a connector for connecting two like pipes end to end, in which a central part of the body has a region with an external diameter equal to the outside diameters of the two pipes.

A releasable connector for joining two pipes of different internal diameter end to end, may include two connectors and a single operating rod extending between two split sleeves arranged to bear against respective inner surfaces of the pipes, in which the operating rod has a fixed conical head at one end and a threaded nut at the other end and such that the sleeves are urged outwards by relatively rotating the pipes to fix the pipes together.

Embodiments of the invention provide connectors, which can be releasable in case of need, from a tube or a hole in a wall say. The connectors can be used to capture a screwed nut inside the tube or hole, although connectors are normally used for connecting two tubes together end to end. Furthermore, by using or forming two or more connectors together, a multiple structural node connector can be provided where a multiple arm connector connects several tubes together.

### BRIEF DESCRIPTION OF THE DRAWINGS

Connectors according to the invention will now described by way of example with reference to the accompanying drawings in which:

FIG. 1 shows a schematic sectional view of one embodiment;

FIG. 2 shows a schematic sectional view of a second embodiment;

FIG. 3 shows a schematic sectional view of a third embodiment;

FIG. 4 shows a schematic sectional view of a fourth embodiment;

FIG. 5 shows side view of a fifth embodiment;

FIG. 6 shows a schematic sectional view of a sixth embodiment;

FIG. 7 shows a schematic sectional view of a seventh embodiment;

FIG. 8 shows a schematic sectional view of an eighth embodiment;

FIG. 9 shows a schematic sectional view of a ninth embodiment;

FIG. 10 shows a schematic sectional view of a tenth embodiment;

FIG. 11 shows a schematic sectional view of an eleventh embodiment;

FIG. 12 shows a schematic sectional view of a twelfth embodiment; and

FIG. 13 shows a schematic sectional view of thirteenth embodiment.

### DESCRIPTION OF THE PREFERRED EMBODIMENT

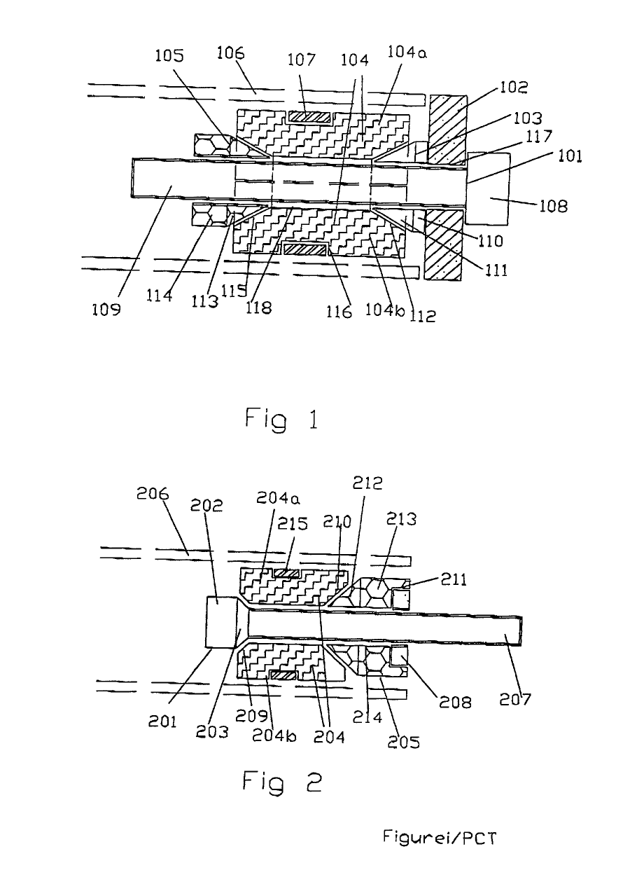

Referring to the drawings, in FIG. 1 a plate 102 has central hole 117. A screw 101 has a head 108 and a threaded stem 109 extending through the hole 117. Surrounding the stem 109 is a first locking member 103 having a conical part 111 and cylindrical part 110 and central hole for the stem 109. A securing member (or split sleeve) 104, has two like semi-cylindrical bodies 104a and 104b, forming a ‘split sleeve’, with conical cavities 112 and 115 at their ends. The shape of the conical cavity 112 is similar to the shape of the conical parts 111 and 103, but a little smaller. The conical locking body 103 lies between the plate 102 and the securing member 104, having the conical part 111 contiguous to the conical cavity 112. The securing bodies 104a and 104b, rest against each other along their edges as shown by the dashed lines along the centre of the figure. The securing member 104 fits snugly inside and extends along adjacent the end of a tube 106. A strap 107 lies in a central peripheral trough 116 formed in an outer surface of the securing member 104. An outer surface of the strap fits flush with or lies within the outer surface of the securing member 104. The strap 107 is elastic, and retains the two securing bodies, 104a and 104b radially together. There is hole 118 in the securing member 104 that allows the stem 109 of the screw 101, forming an operating rod, to pass through. The securing body 104 lies between the two conical locking bodies 103 and 105. The second locking body 105 has a cylinder part 114, a conical part 113 and a central threaded hole 120. The conical part 113 of the conical locking body is contiguous with the cavity 115 at the other end of the securing member 104. The shape of conical cavity 115 of the securing member 104 is similar to the shape of its counter conical part 113 of the locking body 105.

To operate the connector of FIG. 1, a screwdriver or similar, may be applied to the head 108 of the screw 101. The screw 101 may be rotated appropriately so as to draw the first and second locating bodies 103 and 105 towards each other. The opposing locking bodies 103 and 105 will be urged against the cavities 112 and 115. The securing bodies 104a and 104b will be forced radially outwards to grip against the inside of the tube 106. In this way, the connector grips the tube and so be secured therein so as to prevent movement thereafter of the tube away from the connector, i.e. to the left in the Figure.

To release the connector from the tube, the screwdriver is inserted to undo the screw 101 so that the conical locking members 103 and 105 are moved away from one another. This removes the radially outward compression force applied by the securing bodies 104a and 104b. Tension in the elastic strap 107 restores the securing bodies to the original position, allowing the securing bodies to be slid out of the end of the tube 106.

Preferably at the interface extending along (the dashed line) between the securing bodies 104a and 104b, locating pins may be provided to prevent the securing body 104a from sliding longitudinally relative to the securing body 104b.

Preferably the securing member 104 is formed by material with some elasticity such as a plastic material, and one of the interfaces between securing bodies 104a and 104b may then be welded together, allowing the bodies to hinge along that interface. Thus, when the screw 101 rotates longitudinal pressure applied by the conical locking bodies 103 and 105 will make the securing member deform at least to some extent radially outwards. Deformation at the outer surface of the securing member causes the outer surfaces to be urged against the inside of the 106 to establish frictional grip and secure the connector in the tube.

The tube is arranged to be connected to the plate 102. By making the appropriate adjustment of the shape of the end of the tube and the length of the screw, this connector can be arranged to attach a tube to a planar surface of some other object, if required. Without the plate 102, the connector can still provide a friction grip with the tube 106 by rotation of the screw.

FIG. 2 shows an alternative embodiment of the invention shown in FIG. 1, for fixing a screw with the stem of the screw extending out from the tube.

In FIG. 2, a screw 201 has a screw head 202, a conical base 203 and a stem 207, which conical base 203 of the screw 201 acts as the conical part 111 of the first conical locking body 103 in FIG. 1. The conical base 203 of the screw 201 is contiguous with a concave cavity 209 of the securing member. on the other end of the securing member 204 is the locking body 205, having a hexagonal threaded nut 208 is an indentative hole 211 in its base. The conical locking 205 has a cylindrical part 213 and a conical part 212 and a hole 214, having a hexagonal cylindrical slot 211 at the base of a cylindrical part 213. The hexagonal nut 208 is positioned in the hexagonal hole 211 on the stem 207 of the screw 201, Rotation of the screw 201 urges conical locking parts 203 and 212 towards each other. Hence, the locking body 205 and the screw nut 208 functions similarly as the conical locking member 105 in FIG. 1.

To operate the connector in FIG. 2, the connector is inserted into a tube 206 with the stem 207 of the screw 201 extending out of tube. A suitable wrench can rotate the conical locking body 205 and the trapped nut 208 is draw along the threaded stem 207. Friction between the securing member and the interior of the tube 206 prevents the rotation of the securing member 204. The connector is thus operated in the same manner as in FIG. 1 so that the connector can be secured in the tube. This fixes a screw, formed by the exposed thread stem 207, at the end of the tube 206.

Before the connector is inserted into the tube, it is envisaged that the securing member 204 can be adjusted to be able to be snugly inserted into the bore of the tube 206. This is done by rotating screw 201, so that the two locking bodies, conical base 203 of the screw and the conical locking body 205 with the nut 208, suitably compress the securing bodies 204a and 204b. The surface of the securing member is adjusted so that some friction will exist when the connector is first inerted in the end of the tube. Thus, when the screw is first tightened, the securing member will not rotate inside the tube.

Part of the surface of the cylinder part 213 of the conical locking body 205 may have flat surfaces or other suitable shapes, for example the cylinder part may be hexagonal in cross-section. This fascilitates a wrench to grip the conical locking body 205 during locking or unlocking of the connector.

A tube provided with an exposed screw at its end can be used to connect the tube against a surface of a plate using a separate nut. The tube can also be connected to another tube, where the tube with the screw at its end, acts as a special screw for another connector. The connector can also be used to fix an exposed screw in an aperture in an object.

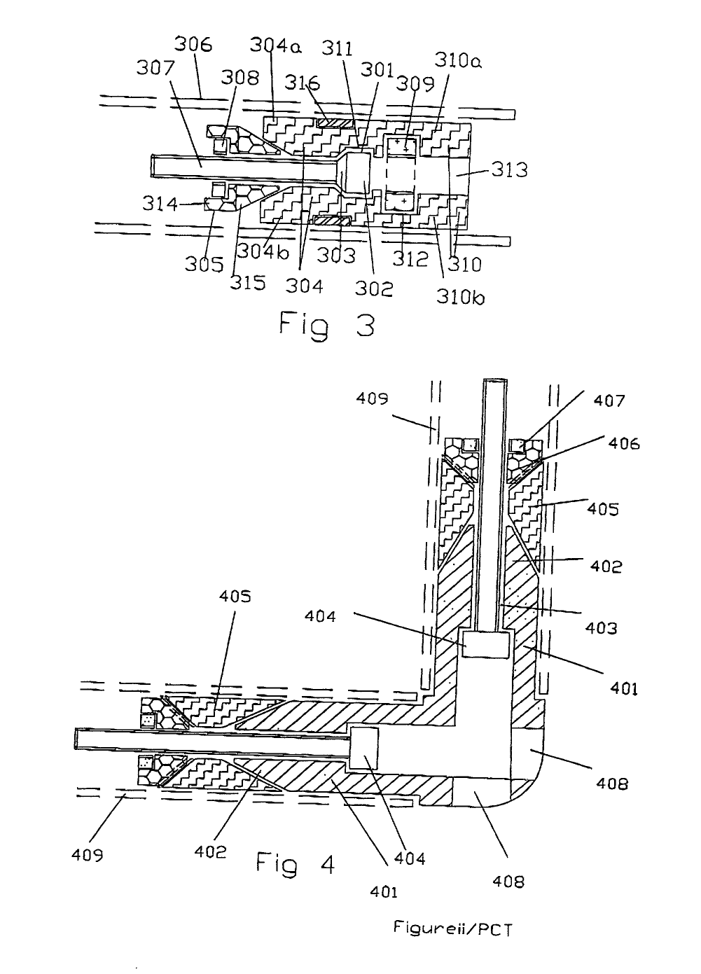

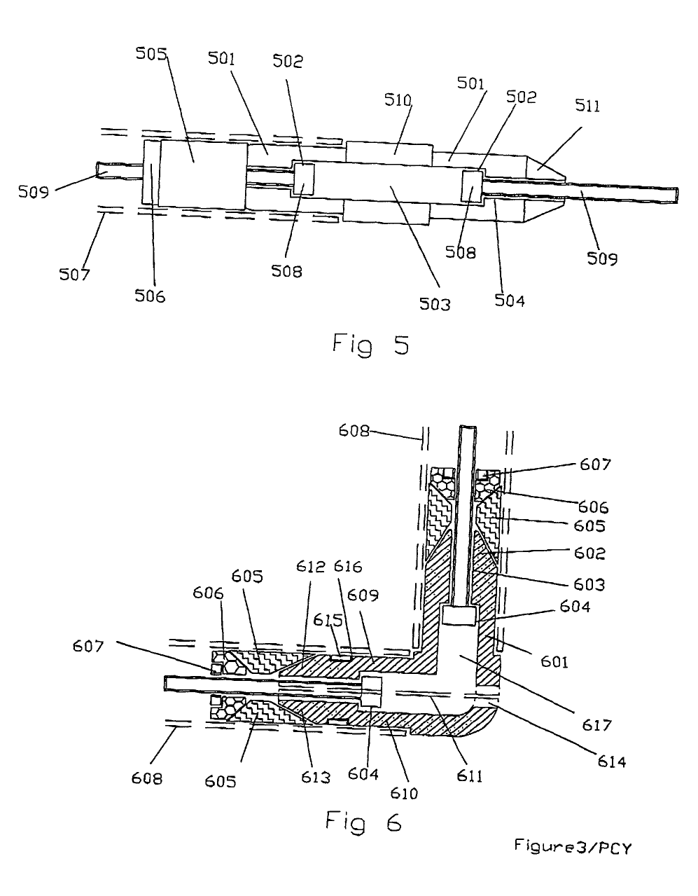

FIG. 3 shows a third embodiment of the invention for connecting a threaded nut to a tube.

The arrangement in FIG. 3 is a modification of the connector shown in FIG. 2. Main securing bodies 310a and 310b are integrally forward with bodies 304a and 304b. There is a hole 313 in main bodies 301a and 301b that acts as an access aperture for a screwdriver or similar implement. A screw head 302 lies inside the main bodies 310a and 310b. A cavity 312 is provided to receive a hexagonal nut. A conical base 303 of the screw head 302 acts as the first conical locking body. A conical locking body 305 with the threaded nut 308 in a slot 315 at a base cylinder 314 acts as the second conical locking body. The connector, with the screw nut 309 in cavity 312, is inserted into the tube 306. A screwdriver can passes through the aperture 313 and the centre of the nut 309 for fixing the connector inside the tube 306.

The described connector can be easily connected to a plate by a screw passing through the plate. Where the diameters of two tubes are the same, the tubes in FIGS. 2 and 3 can be connected directly end to end. The tubes may be connected together with an intervening plate, where the plate acts as an adapter where required, Such combination of tubes and plates, with holes in the plates, can be used to build shelves that can be easily assembled and disassembled using the described connectors.

FIG. 4 shows the fourth embodiment of the present invention. The connector includes a right-angular metallic body 401 with conical heads 402, having access holes 408 at right angles to each other, for receiving the stem 403 of the locking screws 404. Securing members 405 surround the screws 404, Conical heads 402, conical locking bodies 406 and threaded nuts 407 are provided. Turning screws 404 enables each connector to be fixed, or locked, to the tubes 409 in the same manner as before.

FIG. 5 shows an alternative to the connector of FIG. 4. An elongate body 501 has screws 502 entered sideways through open sided Unshaped grooves 503 and 504. The grooves are formed with screw holes, which extend through opposite ends of the body 501 and a conical locking head 511 extending along the axial direction. A trench above the axial plane has a width equal to the diameter of the corresponding hole. Screw heads 508 lie in the U-shaped groove 503, which groove is the operating groove for the screws. The body Sol is enlarged centrally at 510, the peripheral surface of which is flush with the outer surface of a tube 507. At the left-hand of the screw 502 is a securing member 505, and a conical locking body 506 positioned inside the tube. Tightening of the connector fixes the screw in the axial position of the tube automatically.

FIG. 6 shows a sixth embodiment of the invention shown in FIG. 1. An arm extending in the vertical direction is the same as that shown in FIG. 4. However, an arm extending in the horizontal direction has two like parts 609 and 610. The opposing parts 609 and 610 have conical heads 612 and 613. The two parts are held together by an elastic strap 615 that lies in a trough 616 formed in the outer surface of the horizontal arm. An outer surface of the strap is flush or within the outer surface of the arm. There are small locating pins (not shown) at the interface between body 609 and 610, that prevent of the interface surfaces from sliding along each other. An access aperture 614 for a horizontal screw 604 is provided.

To operate the connector in FIG. 6, the body 601 and conical head 602 of the connector is set to be contiguous with the securing member 605 about the stem of the screw 604, On the end of the screw 604 is the hexagonal threaded nut 607, which being in the indentative slot in the base of conical locking body 606 is contiguous with the other end of the securing body 605. An arm of the connector is inserted into the vertical tube 608. A screwdriver or similar can be used rotate the screw 604 to secure the connector arm to the tube 608. The bodies 609 and 610, and the conical heads 612 and 613, and the second screw 604 in the screw hole are then fixed together by the strap 615. Securing member 605, and the conical locking body 606, with nut 607, are then assembled together and are inserted into the horizontal tube 608. A screwdriver can then used to operate the second connector through the aperture 614, and to secure the connector on the horizontal tube.

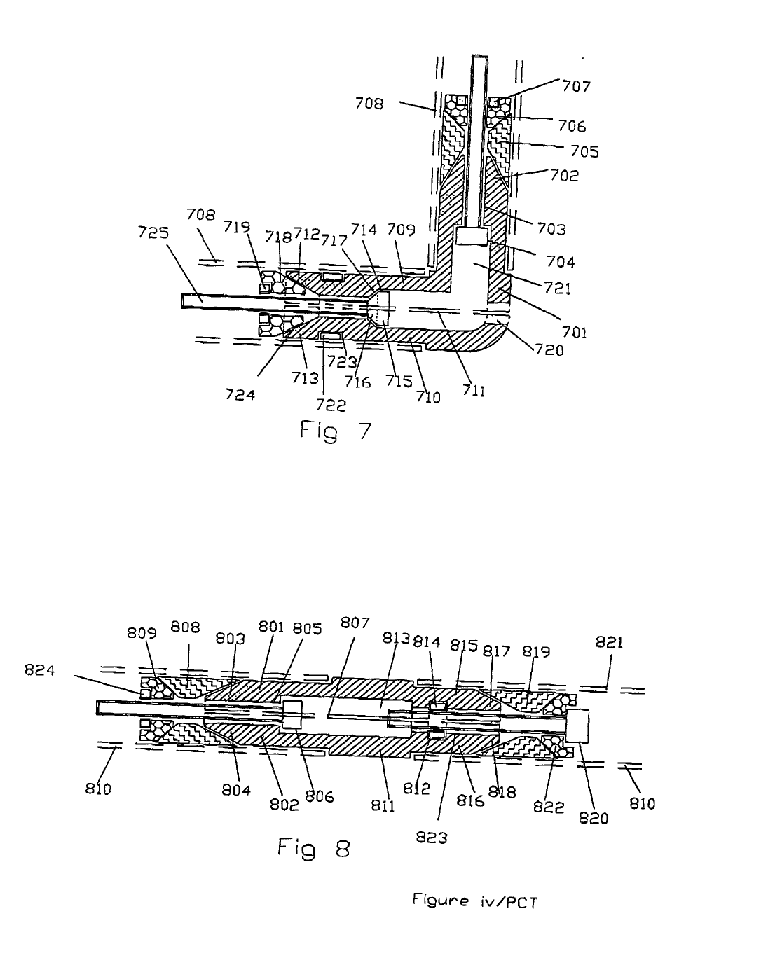

FIG. 7 shows another embodiment of the present invention for a multiple arm connector that has two arms perpendicular with each other. The arm in the vertical direction is the same as that in FIG. 6, while the arm in the horizontal direction has body parts 709 and 710 integrally formed with securing members 712 and 713; the body is halved across the horizontal plane 711. The body 701 of the vertical arm is integral only with the body 709 of the horizontal ann. The connector in the horizontal direction is similar to that used in FIG. 3 for fixing a threaded nut in a tube, except no nut is required. Instead there is an access aperture 720 in the body, for a screwdriver or similar.

To operate the multiple arm connector of FIG. 7, the body 701 with a conical head 702, a screw 704, a securing member 705, and a conical locking body 706 with a nut 707 are joined, as in FIG. 6. The arm is then inserted to a tube 708, and is secured to the tube 708 using a screwdriver entered through the hole 721. The horizontal body 709 is integral with the securing body 712, while the body 710 is integral with the securing body 713. A trough peripheral 723 is provided in the outer surfaces of the securing members 712 and 713. The bodies 709 and 720 with the securing members 712 and 713 of the horizontal arm are then brought together with a screw 715 in position, and held together by a strap 722. The outer surface of the elastic strap 722 is flush with the outer surface of the arm. The screw 715 has a conical base 716, which conical base 716 is assembled in the corresponding conical cavity of the securing member 725. The conical locking body with a nut 719 is on the stem 717 of a screw 715 and in the conical cavity 724 in the other end of the securing member 712 and 713. The arm is then inserted into the second tube 708. A screwdriver can then be used to secure the connector to the tube 708.

FIG. 8 shows an alternative embodiment of a multiple arm connector that has two in-line arms and a body formed by two semi-circular cylinders with convex conical ends 803 and 804, and 817 and 818. The arm at the left-hand side is similar to the horizontal arm of the connector in FIG. 6 that fixes a threaded nut to a tube. The body 811 extends in an opposite direction (to the right) to form a second arm of the connector. A threaded nut 814 is trapped in the second arm. The second arm has bodies 815 and 816 with convex conical ends 817 and 818 and central hole 823. The components of the connector for the left-hand arm, the convex conical end 803 and 804, the securing member 808 and the conical locking body 809 is similar to the horizontal arm of the connector in FIG. 6 in the second arm with the screw nut 824, and the screw nut 814, are then assembled to the horizontal arm as in FIG. 4, and inserted into a tube 810. A screwdriver, or other driving implement, can pass through a hole 823 in the right arm and the hole of the screw nut 814 for securing the left-hand side connector to the tube 810. The conical end 817 and 818 of the second arm, the securing member 819, the conical locking body 822, with slot 825, receive an hexagonal head of the screw 820 and are then adjoined with each other as shown in FIG. 8.

To operate the connector in the right-hand arm, the conical locking body, with the screw 825, is rotated to thread the screw towards the nut 814. The sloping surfaces of the conical locking bodies 817, 818 move against the sloping surfaces of the locking body 822, to force the securing member to move radially outwards. The connector is adjusted so that the securing body 819 may be inserted into the tube 821 with at least some friction. The right-hand arm is then inserted into the tube 821. Tube 821 is then rotated. The established friction between tube 821 and the securing member 819, and the friction between the conical locking body 825 and the securing body 819, make the securing member 819, the conical locking body 825 and the screw 820 follow the rotation. Hence, the screw 825 threads further into the nut 814, so that the securing body 819 is further compressed and the connector is secured in the tube.

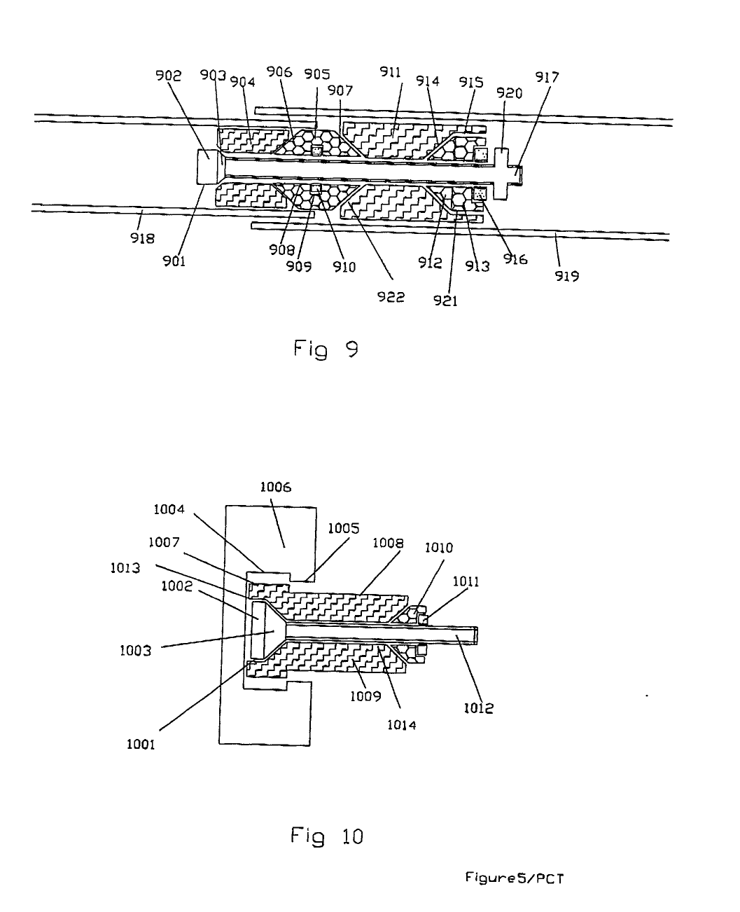

FIG. 9 shows another embodiment of the present invention for forming a composite tube with an adjustable length. A smaller diameter tube 918 is entered into a larger diameter tube 919, and (locked) fixed to the larger tube 919 by operating the connector by rotating the tubes relative to one another.

Firstly, a screw 902 is held inside the smaller tube with its conical base 903 on a screw head 901 against a securing body 904 and a conical locking body 906. A trapped threaded nut 910 lies in a slot 909, similar to the arrangement of FIG. 2. The screw 902 has to be tightened and once fixed, the nut 910 can be welded to the screw stem 917 to fix it permanently in position. A convex conical locking body is provided by a body with two convex conical bodies 906 and 907 on opposite sides of a body 905, with a screw hole 908 and a slot 909 for entrapping the nut 910. A U-shaped trough can be used instead of the hole 908.

The smaller tube with the screw 901 fixed at its end acts as a screw. The screw 901, the conical locking body 907, the securing member 911, and the conical locking body 921 with hexagonal nut 916 on the stem 917 of the screw 901 forms the connector for the larger tube. A hexagonal cylinder part 913 and a conical part 912 form the conical locking body 921. The base of the hexagonal cylinder has a smaller hexagonal cylindrical hole to embrace the nut 916. The securing member 911 is made of material with some elasticity, such as nylon, which is relatively easy to deform. The securing member has a conical cavity 922 at one end which is provided to receive the convex conical body 907 of conical locking body 905. A cavity at the other end of the securing member is formed by two parts, that are indentative to the conical locking body 921, a hexagonal cylindrical hole 915 and a conical cavity 914. The securing member has one slit and two trenches along the axial direction at 120° with each other. An interior solid base section of the trench is a definite fraction of the thickness of the material used, to ensure the flexibility and diminish the radius of the securing member slightly. The radius of the securing member at the central part is equal to or a little larger than the interior radius of the tube. The flexibility of the securing member enables it to be inserted into tube while establishing some initial rotational friction against the interior surface of the tube. The plate 920 is welded to the stem after the connector of the larger tube is set contiguous therewith. The connector is then inserted into tube 919 to the position required. To operate the connector for the larger tube, the tubes are rotated relative to one another. An established friction exists between the inner surface and the securing member 911. The rotation turns the hexagonal cylinder body 913 of the conical locking body 921, being in the hexagonal cylinder cavity 915, and the hexagonal screw nut 916 in the hexagonal slot 923 of the conical locking body 921 rotate together. The screw nut 916 threads forward along the stem 917 of the screw 901 towards the conical body 907 of the conical locking body 905. This makes the conical parts 912 and 907 press against the surfaces of the conical cavities 914 and 922 of the securing member, forcing the body of the securing member 911 to move radially outwards to grip on the inner surface of the tube 919. As the operation continues, the connector and the smaller tube 918 are secured to the larger tube 919.

To release the connector from the larger tube 919, the tubes 918 and 919 are rotated relatively in a reverse direction. The rotation of the tube 919 will cause the securing member 911, the conical locking 921, and the screw nut 916 to rotate together. Hence the nut 916 threads outwards, with the conical locking body. Hence, the radial pressure caused by the securing member is released. This allows the connector to slide along the tube. The plate 920 here is used to prevent the screw nut 916 unscrewing completely,

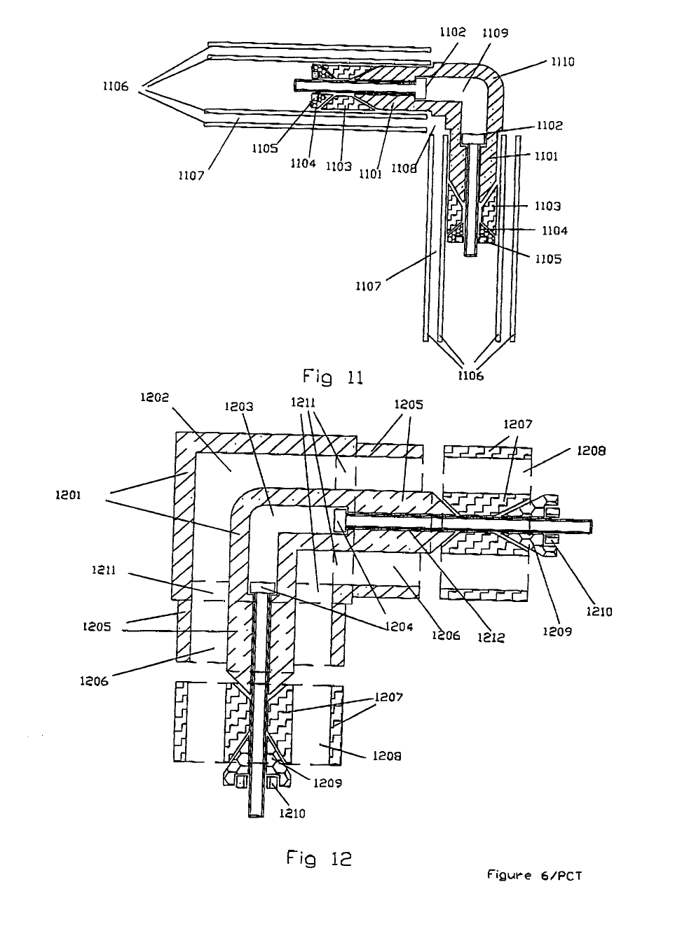

FIG. 10 show a further embodiment of the present invention. An aperture or cavity in a body 1006 is formed with an outer hole 1005 and an inner larger hole 1004. The connector is similar to that used for locking a screw inside a tube, except a securing member 1009 is formed by two cylinders, a larger cylinder 1007 and a smaller cylinder 1008. The larger cylinder 1007 can fit snugly through the smaller hole 1005. When this connector is used and the securing bodies first move outwards, the larger cylinder 1007 fits against the larger hole 1004, and the smaller cylinder 1008 fits against the smaller hole 1005. A screw 1001 with an hexagonal screw head 1002 and conical base 1011 is entrapped in a cavity 1013. A threaded nut 1001, a securing member 1009, and a conical locking body 1010 are fitted together as shown in FIG. 10. Rotation of the conical body 1010 will force the securing bodies to move outwards, the cylinder 1007 in the hole 1004, and the cylinder 1008 in the hole 1005, to grip and inside to the hole 1005, Silicon gel can be introduced into the hole 1005 before the connector is inserted into the hole.

FIG. 11 and FIG. 12 show the further embodiments of the present invention that allow electrical wires to be housed inside the framework.

In FIG. 11, a tube 1106 to be connected is formed by an inner tube and an outer tube with a space 1107 between them for accommodating an electric wire. A multiple arm connector has elongate bodies for arms to connect the inner tubes 1109 together. There is sufficient space for the wire around the outside of the body of the connector. Bodies and arms with U-shape grooves are used. The elongate bodies make the outer tubes to be contiguous with each outer. There is cover (not shown) on an elbow of the connector that is flush with the outer tube 1110 to make the connector visually aesthetic. Wires can easily passes through the space 1107 and an outer space between the connector and the cover. A body 1110, an arm 1101, a screw 1102, a securing member 1103, a conical locking body 1104, with a nut 1105, are brought together as shown in FIG. 11 in a similar manner as in the other embodiments. Rotation of a screw in a groove 1109 will secure the tubes to the connector.

In FIG. 12, a body 1201 of the connector has an inner body 1201a and outer body 1201b, which are connected at a base. An arm 1205 also has an inner arm 1205a and an outer arm 1205b that are connected at the base. Between the inner body 1201a and the outer body 1201b, there is space 1202, and between the inner arm 1205a and the outer arm 1205b, there is a space 1206. For the securing body together there is a hole 1208 extending along in an axial direction. Conical locking bodies are comparatively reduced in diameter to create a space tor an electric wire. Each body has U-shaped grooves 1203 and 1212 for receiving a screw 1204. The body 1205, securing member 1207, conical locking member 1209, with a nut 1210, are brought together as shown in FIG. 12, similarly to the other embodiments. Respective arms are then inserted into the tubes. The rotation of the screw, using a screwdriver, will secure the tubes to the connectors.

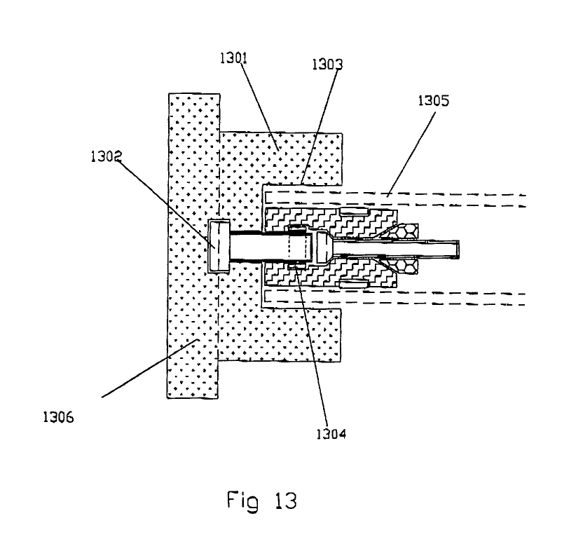

FIG. 13 shows another embodiment of the present invention for fixing a tube to a planar surface. A cylindrical body 1301 is welded to a plate 1306. Inside the body 1301 there is a circular hole 1303, with a diameter the same as a tube 1305. A screw 1302 is fixed in the hole as shown. A tube 1305 with a nut 1304 is provided in the manner described with reference to FIG. 3. A nut 1304 in the tube 1305 is threaded onto a screw 1302. This connector arrangement can be used to stabilise (i.e. attach) tubular legs to a stool or a table for example.

In the specification and claims, the terms “tubes” or “pipes” are used; for the purposes of the invention these terms are intended to be generically the same. In providing connectors of the invention tubes or hollow pipes can be connected and fixed or “locked” together by the gripping of their ends using the connectors. It is of course also possible to connect solid tubes together provided their ends are provided with cylindrical apertures of sufficient depth to receive the split bodies or sleeves of the connectors. As a result and in fixing connectors firmly to such solid tubes, the split bodies are forced or urged radially outwards by the opposing cones (conical ends) that are driven towards each by various threaded operating rods, typically screws or theaded stems, as described above.

The tubes or pipes may have rectangular cross-sections, and where solid formed with cavities at their ends to receive the connectors that are either as described, or rectangular. For a rectangular cavity as will be typical of rectangular tubes, the split sleeve will normally, but not necessarily, be also provided with a rectangular cross-section. A rectangular cross-section generally provides better friction and gripping against inside surfaces of the tube and so is more reliable when the connectors are in their operative configurations. A rectangular split sleeve is preferably formed of two like parts for convenience in use, but may be formed of four like parts, if preferred or desired.

It will be noted in the described embodiments that normally the split bodies are formed with conical end surfaces to receive the opposing cones. It is possible “omit” the conical end surfaces, in which case the cones will still act, as they are drawn towards each other, to urge the split sleeves radially outwards. Thus, the split body may simply have a central passage of sufficient diameter to receive the noses of the cones.

In the above cases, and in the cases described, the outer surfaces of the sleeves fit firmly against inner surfaces of the tubes when the connectors are secured in position. It will be appreciated that the outer surfaces of the sleeves normally extend well into the ends of the tubes and this provides an extended support for the tubes adjacent their ends that helps resist any bending moments applied to the ends of the tubes. This also applies where the connectors are used to fix and locate a tube to a planar surface formed by part of a wall or a table top.

In the described embodiments the ‘locking bodies’, or split sleeves, are made up of two like generally semicylindical parts. It will be appreciated that the locking bodies may be made up of the three or more parts that together, when assembled for insertion into the end of a tube on pipe, make up into a hollow cylinder.

1. A releasable connector for connecting to one end of a tube comprising a split elongate sleeve that fits snugly inside the pipe, a pair of opposing cones that are mounted at opposite ends of the sleeve, and an operating rod extending centrally through the sleeve arranged to move the cones towards each other in use to urge the sleeve radially outwards to bear against the inside of the pipe and fix the connector to the pipe in an operative configuration.

2. A releasable connector according to claim 1, in which the connector has an arm formed with a conical end to provide one of the cones.

3. A releasable connector according to claim 2, in which the connector has two arms each with a conical and to form a respective one cone, and in which the connector is arranged to join three pipe together.

4. A releasable connector according to claim 1, in which the connector has two or more arms and is arranged to connect two or more pipes together with longitudinal axes of the pipes angled to one another.

5. A releasable connector according to claim 2, in which the arm has an anchor arranged t o be mounted and restrained by a cavity of a planar surface for mounting the arm to the planar surface, in which the operating arm comprises a threaded bolt partially exposed extending out of one end of the connector into the cavity, when the connector is in its operative configuration.

6. A releasable connector according to claim 1, including a centrally mounted threaded nut entrapped within the connector and accessible from exterior of the connector when the connector is in its operative configuraiton.

7. A releasable connector according to claim 1, including an anchor for securely supporting the connector to a cavity in a planar surface in which the anchor is entrapped in the cavity and inside the sleeve when the connector is in its operative configuration.

8. A releasable connector according to claim 1, in which the elongate sleeve is split into two equal parts.

9. A releasable connector according to claim 8, in which the sleeve parts are resiliently held together radially by a strap that surrounds a periphery of the sleeve.

10. A releasable connector according to claim 1, in which the elongate sleeve is cylindrical and is arranged to fit into a cylindrical cavity in an end of a respective pipe.

11. A releasable connector according to claim 1 in which the operating rod is anchored in an opened sided body that provides one of the cones at one end and allows the operating rod to be inserted side ways into the body.

12. A releasable connector according to claim 11, in which the body has a cone at each end, respectively forming part of a connector for connecting two like pipes end to end, in which a central part of the body has a region with an external diameter equal to the outside diameters of the two pipes.

13. A releasable connector according to claim 1, for joining two pipes of different internal diameter end to end, including two connectors and a single operating rod extending between two split sleeves arranged to bear against respective inner surfaces of the pipes, in which the operating rod has a fixed conical head at one end and a threaded nut at the other end and such that the sleeves are urged outwards by relatively rotating the pipes to fix the pipes together.
